(19) United States
(12) Patent Application Publication
(10) Pub. No.: US 2026/0351100 A1
(43) Pub. Date: Nov. 5, 2026

(54) Dual-Function Emergency Alert and Illumination Device

(71) Applicant: Doyle Morrish, Aurora, CO (US)

(72) Inventor: Doyle Morrish, Aurora, CO (US)

(21) Appl. No.: 19/460,425

(22) Filed: Jan. 27, 2026

Related U.S. Application Data
(60) Provisional application No. 63/797,157, filed on Apr. 30, 2025.

(51) Int. Cl. G08B 7/06; F21K 9/238; F21V 23/04; F21Y 115/10; H05B 45/20; H05B 47/11; H05B 47/19

(52) U.S. Cl. CPC G08B 7/064; F21K 9/238; F21V 23/0435; F21V 23/0464; H05B 45/20; H05B 47/11; H05B 47/19; F21Y 2115/10

(57) ABSTRACT

A dual-function emergency alert and illumination device configured for installation into a standard light socket is disclosed. The device includes a bulb housing containing at least one light-emitting element capable of emitting a first color illumination during a non-emergency mode and a second color illumination during an emergency mode. A dusk-to-dawn photocell automatically controls activation of the non-emergency mode based on ambient light conditions. A wireless communication module, operable via Wi-Fi, Bluetooth, or cellular protocols, receives emergency activation signals from remote sources including mobile applications, personal emergency alert devices, remote notification systems, and/or automated emergency call detection. A control module switches the device from the non-emergency mode to the emergency mode, in which the second color is emitted in a flashing pattern visible from a distance and maintains this mode until a reset signal is received.

### CROSS-REFERENCE TO RELATED APPLICATION

The present application claims priority to, and the benefit of, U.S. Provisional Application No. 63/797,157 which was filed on Apr. 30, 2025 and is incorporated herein by reference in its entirety.

### FIELD OF THE INVENTION

The present invention generally relates to lighting and emergency signaling systems. More specifically, the present invention relates to a dual-function emergency alert and illumination device configured to operate both as a standard outdoor porch light and as a high-visibility emergency beacon. The device comprises a bulb housing with a threaded connector for installation into a standard light socket, enclosing at least one light-emitting element capable of producing a first color illumination during normal operation and a second, highly visible color illumination during emergency operation. The device further includes a dusk-to-dawn photocell for automatic non-emergency operation control, a wireless communication module for receiving emergency activation signals via multiple communication protocols, and a control module for switching between modes. The emergency mode produces continuous or flashing illumination in the second color to enable rapid visual identification of the residence, thereby improving emergency response times, assisting vulnerable occupants, and enhancing neighborhood awareness. Accordingly, the present disclosure makes specific reference thereto. Nonetheless, it is to be appreciated that aspects of the present invention are also equally applicable to other like applications, devices, and methods of manufacture.

### BACKGROUND

By way of background, in emergency situations, immediate and accurate identification of the correct location is critical for effective response. While GPS navigation can guide emergency personnel to a general address, GPS may not pinpoint the exact unit, door, or entry point in multi-unit dwellings such as apartment complexes or in large, densely built neighborhoods. The lack of precise visual identification can lead to delays, as first responders may need to verify individual addresses before providing assistance.

Elderly individuals, disabled persons, or medically vulnerable occupants may be physically unable to reach or operate a phone to call for help. In such cases, the absence of an accessible, non-verbal method for signaling distress further impedes emergency response. Standard outdoor or porch lights provide only general illumination and offer no means of visually distinguishing a residence experiencing an emergency from surrounding properties, resulting in potential loss of valuable time during critical situations. Accordingly, individuals desire an improved porch light system that serves as a visual alert system for emergency situations, helping first responders and neighbors quickly identify the correct residence for a person in need.

Therefore, there exists a long-felt need in the art for an illumination device that enables immediate and precise visual identification of a residence during emergency situations. There is a longstanding need for a porch light system that not only provides standard outdoor illumination but also transitions into a high-visibility emergency beacon when triggered. Further, there is a need in the art for an emergency alert device that can be remotely activated through multiple communication channels. Additionally, there is a need for a signaling system that assists elderly or medically vulnerable individuals in calling for help without requiring verbal communication or physical travel to a phone. Furthermore, there exists a need for an energy-efficient, dusk-to-dawn enabled device that remains in constant standby mode for 24/7 readiness. Finally, there is a need for a porch-mounted alert system that reduces response times for first responders and increases community awareness during emergencies.

The subject matter disclosed and claimed herein, in one embodiment, comprises a dual-function emergency alert and illumination device configured in the form of a replaceable smart light bulb. The device includes a bulb housing with a threaded connector for installation into a standard light socket and at least one light-emitting element capable of emitting a first color, such as white, during non-emergency operation and a second color, such as red, during emergency operation. A photocell is integrated into the device to enable dusk-to-dawn functionality, automatically activating the first color at night and deactivating it during the day to conserve energy. A wireless communication module within the bulb housing is configured to receive emergency activation signals via Wi-Fi, Bluetooth, or cellular networks. A control module processes incoming signals and switches the device into emergency mode, in which the second color is flashed continuously until a reset signal is received.

In one embodiment, the light-emitting element comprises a multi-color LED array capable of producing both white and red illumination, with the control module modulating color output via pulse-width control.

In this manner, the dual-function emergency alert and illumination device of the present invention addresses longstanding shortcomings in conventional porch lighting systems by combining standard outdoor illumination with a visible, non-verbal emergency signaling capability. The device enables first responders to identify the correct residence quickly, assists vulnerable occupants in calling for help without speech, and provides a constant state of readiness through energy-efficient operation. The device integrates illumination control and wireless communication and offers a reliable and safety solution that also helps elderly individuals or medically vulnerable persons signal for help without needing to speak.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a dual-function emergency alert and illumination device. The device comprises a bulb housing having a threaded end that is configured for installation into a standard light socket. At least one light-emitting element is disposed within the bulb housing. The light-emitting element is configured to selectively emit illumination in a first color during a non-emergency mode and in a second color during an emergency mode, with the first color being different from the second color. A photocell is electrically coupled to the light-emitting element. The photocell is configured to detect ambient light levels and to automatically activate the non-emergency mode when the ambient light level is below a first threshold and to deactivate the non-emergency mode when the ambient light level is above the first threshold.

In one embodiment, a wireless communication module is provided and is configured to receive an emergency activation signal from at least one remote triggering source. A control module is electrically coupled to the light-emitting element, the photocell, and the wireless communication module. The control module is configured to switch the light-emitting element from the non-emergency mode to the emergency mode in response to the emergency activation signal. In the emergency mode, the light-emitting element flashes in the second color until a reset signal is received.

In another embodiment, a lighting and alert system for a residence is disclosed. The system comprises a replaceable light bulb assembly dimensioned for installation in a standard light socket. The system includes a plurality of light-emitting diodes arranged to provide illumination in at least a first color and a second color. A photocell or light sensor is provided and is configured to automatically control the first color illumination based on ambient light conditions. A wireless communication module is configured to accept an emergency activation signal from at least one of a mobile application, a personal emergency alert device, a remote emergency notification system, or an automatic detection of an emergency call. A control module is coupled to the light-emitting diodes and is configured to control the illumination such that, upon receipt of the emergency activation signal, the second color illumination is emitted in a flashing pattern that is visible from a distance.

In one embodiment, an emergency signaling light device comprises a bulb housing having an Edison-type threaded connector. An illumination module is disposed within the bulb housing and includes at least one multi-color LED configured to produce white illumination during a non-emergency mode and red illumination during an emergency mode. A dusk-to-dawn light sensor is coupled to the illumination module and is configured to automatically enable the non-emergency mode during nighttime hours and to disable the non-emergency mode during daytime hours. A wireless transceiver is integrated into the bulb housing and is configured for communication over at least one of Wi-Fi, Bluetooth, or cellular networks. A control circuit is coupled to the illumination module, the dusk-to-dawn light sensor, and the wireless transceiver. The control circuit is configured to receive a wireless emergency activation signal from a remote device, to activate the emergency mode by flashing the red illumination continuously, and to maintain the emergency mode until a wireless reset signal is received.

In yet another embodiment, a method of operating a dual-function emergency alert and illumination device comprises installing the device into a standard light socket is described. The method further comprises monitoring ambient light levels using a photocell. The method includes activating a first color illumination mode during nighttime conditions when the ambient light level is below a predetermined threshold. The method also comprises receiving, via a wireless communication module, an emergency activation signal from a remote triggering source. In response to the emergency activation signal, the method includes switching from the first color illumination mode to a second color flashing illumination mode. The method maintains the second color flashing illumination mode until a reset signal is received.

In one embodiment, the light-emitting element comprises an RGB or RGBW multi-color LED package configured to produce both the first color and the second color, and wherein the control module utilizes pulse-width modulation to control the brightness and color output of the light-emitting element.

In still another embodiment, the wireless communication module is further configured to integrate with a smart home automation system and, upon activation of the emergency mode, to perform at least one additional action selected from the group consisting of unlocking an entry door, transmitting location data to emergency responders, and activating interior lighting.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of dual-function emergency alert and illumination device of the present invention in accordance with the disclosed structure;

FIG. 2 illustrates a flow chart depicting a process of normal lighting flow (non-emergency operation) of the dual-function emergency alert and illumination device in accordance with the disclosed structure;

FIG. 3 illustrates a flow diagram illustrating an exemplary emergency activation process of the emergency alert and illumination device according to one embodiment of the present invention;

FIG. 4 is a front view of an exemplary graphical user interface on a mobile computing device for controlling the emergency alert and illumination device, according to one embodiment of the present invention;

FIG. 5 illustrates a flow diagram depicting an exemplary reset process of the emergency alert and illumination device according to one embodiment of the present invention;

FIG. 6 illustrates another exemplary graphical user interface for initiating an emergency activation signal based on a 911 call, according to one embodiment of the present invention;

FIG. 7 illustrates an exemplary graphical user interface for initiating an emergency activation signal based on a remote emergency alert, according to one embodiment of the present invention; and

FIG. 8 illustrates a perspective view illustrating the emergency alert and illumination device in operation on a building exterior, according to one embodiment of the present invention.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an illumination device that enables immediate and precise visual identification of a residence during emergency situations. There is a longstanding need for a porch light system that not only provides standard outdoor illumination but also transitions into a high-visibility emergency beacon when triggered. Further, there is a need in the art for an emergency alert device that can be remotely activated through multiple communication channels. Additionally, there is a need for a signaling system that assists elderly or medically vulnerable individuals in calling for help without requiring verbal communication or physical travel to a phone. Furthermore, there exists a need for an energy-efficient, dusk-to-dawn enabled device that remains in constant standby mode for 24/7 readiness. Finally, there is a need for a porch-mounted alert system that reduces response times for first responders and increases community awareness during emergencies.

The present invention, in one exemplary embodiment, is an emergency signaling light device comprises a bulb housing having an Edison-type threaded connector. An illumination module is disposed within the bulb housing and includes at least one multi-color LED configured to produce white illumination during a non-emergency mode and red illumination during an emergency mode. A dusk-to-dawn light sensor is coupled to the illumination module and is configured to automatically enable the non-emergency mode during nighttime hours and to disable the non-emergency mode during daytime hours. A wireless transceiver is integrated into the bulb housing and is configured for communication over at least one of Wi-Fi, Bluetooth, or cellular networks. A control circuit is coupled to the illumination module, the dusk-to-dawn light sensor, and the wireless transceiver. The control circuit is configured to receive a wireless emergency activation signal from a remote device, to activate the emergency mode by flashing the red illumination continuously, and to maintain the emergency mode until a wireless reset signal is received.

Reference will now be made in detail to the present preferred embodiments of the invention, examples of which are illustrated in the accompanying drawings. Wherever possible, the same reference numerals are used in the drawings and the description to refer to the same or like parts.

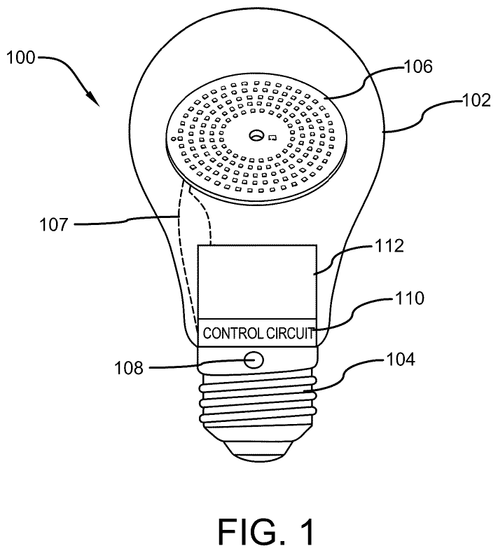

Referring initially to the drawings, FIG. 1 illustrates a perspective view of dual-function emergency alert and illumination device of the present invention in accordance with the disclosed structure. The dual-function emergency alert and illumination device 100 of the present invention is designed as a smart, dual-function LED porch light to act both as a standard outdoor light and an emergency visual alert device. The dual-function emergency alert and illumination device 100 can function as a normal outdoor porch light in everyday use and as a high-visibility emergency beacon during emergency. More specifically, the dual-function emergency alert and illumination device 100 includes a bulb housing 102 dimensioned and threaded for installation into a standard light socket. The bulb housing 102 includes a threaded end 104 for making an electric connection with the standard light socket. The threaded end 104 can be designed to make the device 100 compatible with various light sockets.

The dual-function emergency alert and illumination device 100 includes at least one light-emitting element 106, preferably in the form of a plurality of light emitting diodes (LEDs). The light-emitting element 106 is configured to selectively illuminate in a first color (such as white color or warm color) during a non-emergency operation/mode and in a second color during emergency operation/mode. The first color is different and independent from the second color, and the second color is preferably red color.

The light-emitting element 106 can comprise an RGB or RGBW multi-color LED package configured to produce both the first color and the second color, and wherein the control module utilizes pulse-width modulation to control the brightness and color output of the light-emitting element.

A photocell 108 also referred to as the dusk-to-dawn sensor in the present disclosure is included in the dual-function emergency alert and illumination device 100. The photocell 108 is electrically coupled to the light-emitting element 106 and is configured to automatically activate the non-emergency mode during nighttime conditions and deactivate the non-emergency mode during daytime conditions to save battery of the device 100. Specifically, when the ambient light level drops below a first threshold such as during dusk, the photocell 108 activates the non-emergency mode to turn on the light-emitting element 106 in white color. Conversely, when the ambient light level rises above the first threshold such as during dawn, the photocell 108 deactivates the non-emergency mode, thereby turning off the light-emitting element 106.

A control module/circuit 110 is included in the dual-function emergency alert and illumination device 100 and is electrically coupled to the light-emitting element 106 and the photocell 108 (shown via the phantom line 107). The control module 110 is configured to switch the light-emitting element 106 from the non-emergency mode to the emergency mode when an emergency activation signal is received by the control module 110. The control module 110 can also activate the emergency mode directly even when the device 100 is off such as during daytime. The emergency activation signal is wirelessly received by the control module 110 via a wireless communication module 112 embedded in the dual-function emergency alert and illumination device 100. In the emergency mode, the light-emitting element 106 flashes continuously, for example, in red color until a reset signal is received by the control module 110. The flashing red illumination during emergency operation is visible from a long distance to provide a visual indicator to emergency responders and neighbors of an emergency condition at the location of the device 100.

The wireless communication module 112 is configured to provide a wireless channel for the dual-function emergency alert and illumination device 100 and may use Wi-Fi, Bluetooth, or Cellular communication for receiving the emergency activation signal. The wireless communication module 112 may also support communication APIs such as MQTT and HTTPS for integration with personal emergency alert networks and smart home systems. The wireless communication module 112 is further configured to integrate with a smart home automation system and, upon activation of the emergency mode, to perform at least one additional action selected from the group consisting of unlocking an entry door, transmitting location data to emergency responders, and activating interior lighting.

The control module 110 is also configured to maintain the light-emitting element 106 in, for example, the white (non-emergency) color mode during nighttime conditions in the absence of the emergency activation signal.

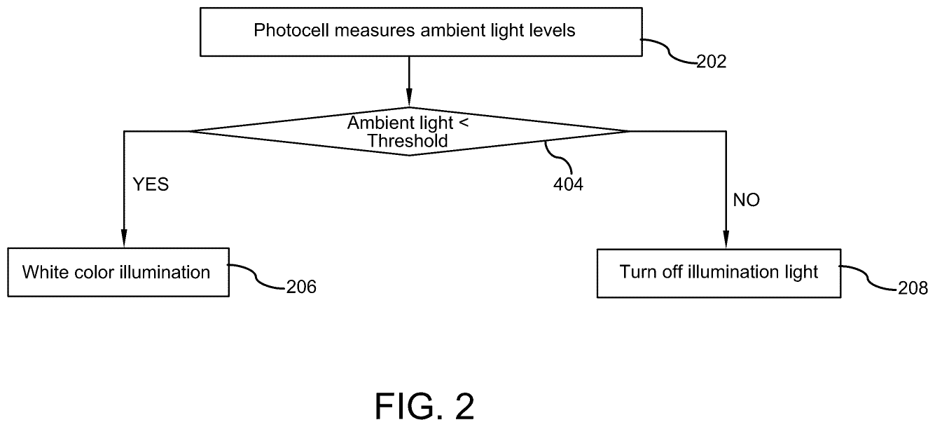

FIG. 2 illustrates a flow chart depicting a process of normal lighting flow (non-emergency operation) of the dual-function emergency alert and illumination device in accordance with the disclosed structure. Initially, the photocell 108 measures the ambient light levels in the surrounding environment (Step 202). Then, the photocell 108 compares the measured ambient light level to a predetermined threshold value (Step 204). If the ambient light level is below the threshold (YES condition), indicating nighttime or low-light conditions, the control module 110 activates the non-emergency mode/white color illumination mode (Step 206). If the ambient light level is equal to or above the threshold (NO condition), indicating daytime or sufficient lighting conditions, the control module 110 deactivates the illumination light element 106 (Step 208). The automatic deactivation enables the dual-function emergency alert and illumination device 100 to automatically conserve power during daylight hours while providing adequate illumination during nighttime, independent of emergency operation triggers/activation.

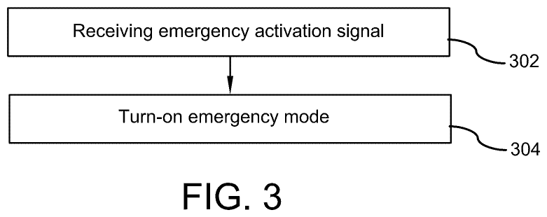

FIG. 3 illustrates a flow diagram illustrating an exemplary emergency activation process of the emergency alert and illumination device according to one embodiment of the present invention. Initially, the wireless communication module 112 of the emergency alert and illumination device 100 receives an emergency activation signal from at least one triggering source, such as a mobile application, a personal emergency alert device, a remote emergency notification system, or an automatic detection of a 911 call from a pre-registered telephone number (Step 302).

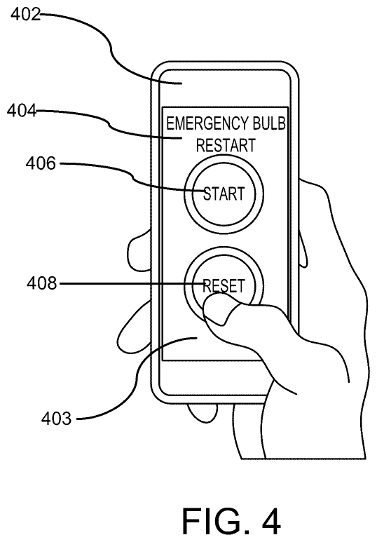

Then, the control module 110 initiates the emergency mode by activating the red illumination of the light-emitting element 106, preferably in a flashing pattern to maximize visibility to first responders and nearby individuals (Step 304). It should be noted that the emergency mode remains active until a reset signal is received, thereby providing continuous visual signaling during an emergency event as described in FIG. 4.

FIG. 4 is a front view of an exemplary graphical user interface on a mobile computing device for controlling the emergency alert and illumination device, according to one embodiment of the present invention. A software application 403 is installed on the mobile computing device 402 and is configured to provide the user interface 404. The user interface 404 includes a start icon 406, which, when actuated by a user, transmits the emergency activation signal to the wireless communication module 112 of the device 100, thereby initiating the emergency mode and causing the illumination light element 106 to emit flashing red illumination.

The interface further includes a “RESET” control button 408, which, when actuated, transmits a reset signal to the device 100, causing the control module 110 to deactivate the emergency mode and return the device 100 to normal operation. The user interface 404 enables remote manual triggering and resetting of the emergency signal, enabling operation from any location with the emergency alert and illumination device. It should be noted that the mobile device 402 can also be in the form of a remote control device.

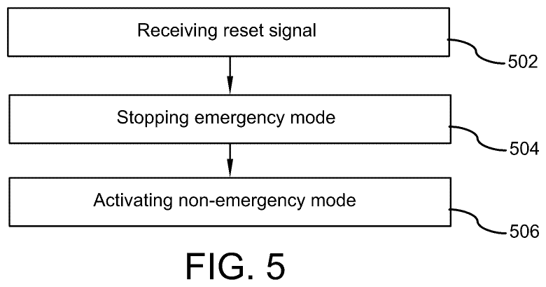

FIG. 5 illustrates a flow diagram depicting an exemplary reset process of the emergency alert and illumination device according to one embodiment of the present invention. Initially, the wireless communication module 112 of the device 100 receives a reset signal from a triggering source, such as a mobile application, remote control device, or other authorized communication system (Step 502). On receipt of the reset signal, the control module 110 stops the emergency mode by terminating the flashing red illumination output (Step 504). Finally, the control module 110 activates the non-emergency mode (Step 506). Depending on the ambient light conditions detected by the photocell sensor, the emergency alert and illumination device may resume white color illumination if nighttime is detected or remain off if daylight conditions are present as described in FIG. 2.

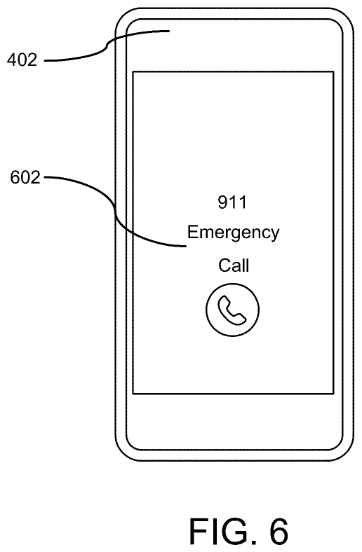

FIG. 6 illustrates another exemplary graphical user interface for initiating an emergency activation signal based on a 911 call, according to one embodiment of the present invention. When a 911 call is initiated from the pre-registered mobile device 402 using the 911 emergency call button 602, the application 404 is configured to automatically transmit an emergency activation signal to the emergency alert and illumination device 100. Upon receipt of the activation signal, the control module 110 of the emergency alert and illumination device enters emergency mode, causing the emergency alert and illumination device to emit flashing red illumination visible from outside the residence.

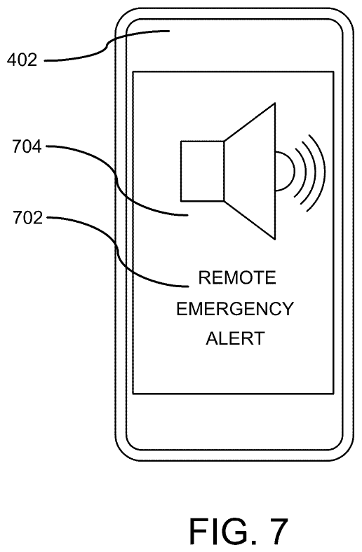

FIG. 7 illustrates an exemplary graphical user interface for initiating an emergency activation signal based on a remote emergency alert, according to one embodiment of the present invention. The user interface 702 is a “Remote Emergency Alert” interface, that displays a speaker emitting alert signal 704. Upon receipt of a remote emergency alert from a designated monitoring service, security system, or other connected network source, the user interface 702 transmits an emergency activation signal to the wireless communication module of the emergency alert and illumination device 100.

In response to the activation signal, the control circuit 110 of the emergency bulb device 100 switches to emergency mode, causing the illumination element 106 (FIG. 1) to emit flashing red light, thereby providing a visible indication of an emergency to first responders and nearby individuals.

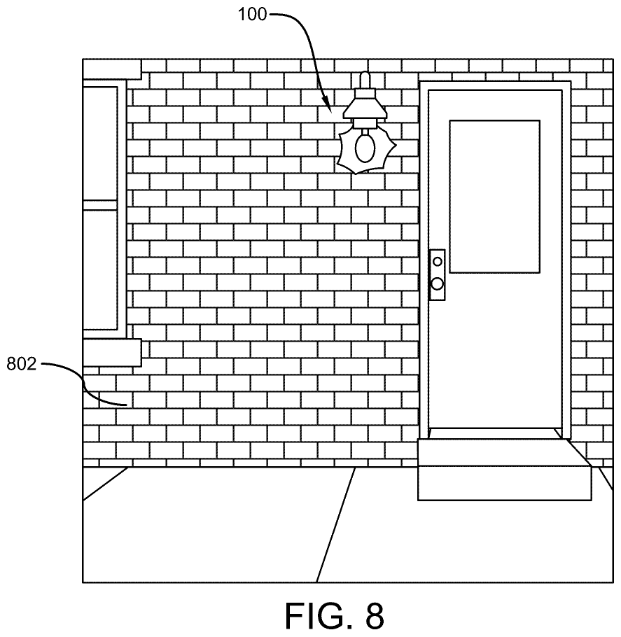

FIG. 8 illustrates a perspective view illustrating the emergency alert and illumination device in operation on a building exterior, according to one embodiment of the present invention. The emergency bulb device 100 can be mounted in an outdoor light fixture positioned adjacent to the entry door of a residence (in a porch 802). The emergency bulb device 100 is shown in an activated emergency mode, emitting a flashing red illumination pattern. The illumination in the emergency mode is visible from a considerable distance, thereby enabling first responders, neighbors, or passersby to quickly identify the location of an emergency.

It should be noted that the device 100 of the present invention works in the non-emergency or normal mode where the device 100 emits standard white light at night, controlled by the photocell to conserve energy during the day. In the emergency mode, the illuminating light flashes bright red light when triggered, serving as a highly visible distress signal.

The emergency bulb device 100 provides immediate identification by enabling first responders and neighbors to quickly locate a home in distress, making it especially valuable for elderly or medically fragile individuals living alone. The device 100 serves as a non-verbal alert system, and signals for help without requiring the person to speak. The bright, flashing red light enhances community awareness, enabling nearby residents to notice the signal and offer immediate help or contact emergency services.

In some embodiments, the device 100 may have an embedded solar panel for capturing solar energy and converting into electricity to provide electrical power to the illuminating light source for illumination.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “emergency alert and illumination device”, “emergency bulb device”, “dual-function emergency alert and illumination device”, and “device” are interchangeable and refer to the dual-function emergency alert and illumination device 100 of the present invention.

Notwithstanding the foregoing, the dual-function emergency alert and illumination device 100 of the present invention can be of any suitable configuration as is known in the art without affecting the overall concept of the invention, provided that it accomplishes the above stated objectives. One of ordinary skill in the art will appreciate that the dual-function emergency alert and illumination device 100 as shown in the FIGS. are for illustrative purposes only, and that many other configurations of the dual-function emergency alert and illumination device 100 are well within the scope of the present disclosure. Although the dimensions of the dual-function emergency alert and illumination device 100 are important design parameters for user convenience, the dual-function emergency alert and illumination device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A dual-function emergency alert and illumination device comprising:
a dual-function LED light;
a bulb housing;
at least one light-emitting element;
a photocell; and
a control module;
wherein said bulb housing comprises a threaded end for installation into a standard light socket to form an electric connection with the standard light socket;
wherein said at least one light-emitting element comprising a plurality of light emitting diodes (LEDs);
wherein said at least one light-emitting element is configured to selectively illuminate in a first color during a non-emergency mode and in a second color during an emergency mode to function selectively as a standard outdoor light and an emergency visual alert device;
wherein said first color is different from said second color;
wherein said control module is electrically coupled to said at least one light-emitting element;
wherein said dual-function LED light is configured to switch said at least one light-emitting element from said non-emergency mode to said emergency mode when an emergency activation signal is received by said control module; and
further wherein in said emergency mode said at least one light-emitting element flashes continuously in said second color.

2. The dual-function emergency alert and illumination device of claim 1, wherein said photocell comprising a dusk-to-dawn sensor.

3. The dual-function emergency alert and illumination device of claim 1, wherein said photocell is electrically coupled to said at least one light-emitting element and is configured to automatically activate said non-emergency mode during nighttime conditions and deactivate said non-emergency mode during daytime conditions.

4. The dual-function emergency alert and illumination device of claim 1, wherein said dual-function LED light is a porch light.

5. The dual-function emergency alert and illumination device of claim 1, wherein said photocell activates said non-emergency mode to turn on said at least one light-emitting element in said first color when the ambient light level drops below a first threshold, and further wherein said photocell activates said non-emergency mode to turn off said at least one light-emitting element when the ambient light level rises above said first threshold.

6. The dual-function emergency alert and illumination device of claim 1, wherein said control module receives the emergency activation with a wireless communication module embedded in the dual-function emergency alert and illumination device.

7. The dual-function emergency alert and illumination device of claim 1, wherein said control module comprises a pulse-width modulation to control the brightness and color output of said at least one light-emitting element.

8. The dual-function emergency alert and illumination device of claim 7, wherein said second color is a red color.

9. The dual-function emergency alert and illumination device of claim 6, wherein said wireless communication module is configured to provide a wireless channel for the dual-function emergency alert and illumination device; and further wherein said wireless channel selected from the group consisting of a Wi-Fi, a Bluetooth, and a Cellular communication.

10. The dual-function emergency alert and illumination device of claim 6, wherein said wireless communication module is configured to integrate with a smart home automation system and, upon activation of said emergency mode, actuates at least one additional action selected from the group consisting of unlocking an entry door, transmitting location data to emergency responders, and activating interior lighting.

11. A method of illuminating a dual-function emergency alert device, the method comprising the steps of:
providing a dual-function LED light, a bulb housing, at least one light-emitting element, and a control module;
threading said bulb housing into a standard light socket to form an electric connection with the standard light socket, wherein said at least one light-emitting element comprising a plurality of light emitting diodes (LEDs);
selectively illuminating said at least one light-emitting element in a first color during a non-emergency mode and in a second color during an emergency mode to function selectively as a standard outdoor light and an emergency visual alert device, wherein said first color is different from said second color;
electrically coupling said control module to said at least one light-emitting element;
switching said dual-function LED light and said at least one light-emitting element from said non-emergency mode to said emergency mode when an emergency activation signal is received by said control module; and
further wherein in said emergency mode said at least one light-emitting element flashes continuously in said second color.

12. The method of illuminating a dual-function emergency alert device of claim 11 further comprising a photocell, wherein said photocell comprises a dusk-to-dawn sensor.

13. The method of illuminating a dual-function emergency alert device of claim 11 further comprising a photocell, wherein said photocell is electrically coupled to said at least one light-emitting element and is configured to automatically activate said non-emergency mode during nighttime conditions and deactivate said non-emergency mode during daytime conditions.

14. The method of illuminating a dual-function emergency alert device of claim 11, wherein said dual-function LED light is a porch light.

15. The method of illuminating a dual-function emergency alert device of claim 12, wherein said photocell activates said non-emergency mode to turn on said at least one light-emitting element in said first color when the ambient light level drops below a first threshold, and further wherein said photocell activates said non-emergency mode to turn off said at least one light-emitting element when the ambient light level rises above said first threshold.

16. The method of illuminating a dual-function emergency alert device of claim 11, wherein said control module receives the emergency activation with a wireless communication module embedded in the dual-function emergency alert and illumination device.

17. The method of illuminating a dual-function emergency alert device of claim 11, wherein said control module comprises a pulse-width modulation to control the brightness and color output of said at least one light-emitting element.

18. The method of illuminating a dual-function emergency alert device of claim 17, wherein said second color is a red color.

19. A method of illuminating a dual-function emergency alert device, the method comprising the steps of:
providing a dual-function LED light, a bulb housing, at least one light-emitting element, a photocell, a control module, a wireless communication module;
threading said bulb housing into a standard light socket to form an electric connection with the standard light socket, wherein said at least one light-emitting element comprising a plurality of light emitting diodes (LEDs);
selectively illuminating said at least one light-emitting element in a first color during a non-emergency mode and in a second color during an emergency mode to function selectively as a standard outdoor light and an emergency visual alert device, wherein said first color is different from said second color;
electrically coupling said control module to said at least one light-emitting element;
switching said dual-function LED light and said at least one light-emitting element from said non-emergency mode to said emergency mode when an emergency activation signal is received by said control module;
flashing continuously in said second color said at least one light-emitting element in said emergency mode;
wherein said wireless communication module comprises a wireless channel for the dual-function emergency alert and illumination device, and further wherein said wireless channel selected from the group consisting of a Wi-Fi, a Bluetooth, and a Cellular communication;
integrating said wireless communication module with a smart home automation system; and
actuating at least one additional action selected from the group consisting of unlocking an entry door, transmitting location data to emergency responders, and activating interior lighting upon activation of said emergency mode.

20. The method of illuminating a dual-function emergency alert device of claim 19, wherein said wireless communication module receives an emergency activation signal from at least one source selected from the group consisting of a personal emergency alert device, a remote emergency alert, a mobile application, a remote control device, and an automatic detection of a 911 call from a pre-registered telephone number.
